(19) United States
(12) Patent Application Publication
(10) Pub. No.: US 2024/0219570 A1
(43) Pub. Date: Jul. 4, 2024

(54) LiDAR-BASED OBJECT DETECTION METHOD AND DEVICE

(71) Applicants: HYUNDAI MOTOR COMPANY, Seoul (KR); KIA CORPORATION, Seoul (KR)

(72) Inventor: Yoon Seok Yang, Seoul (KR)

(73) Assignees: HYUNDAI MOTOR COMPANY, Seoul (KR); KIA CORPORATION, Seoul (KR)

(21) Appl. No.: 18/519,945

(22) Filed: Nov. 27, 2023

(30) Foreign Application Priority Data
Dec. 1, 2022 (KR) 10-2022-0165894

(51) Int. Cl. G01S 17/89; G01S 17/894; G06T 7/73

(52) U.S. Cl. CPC G01S 17/89; G01S 17/894; G06T 7/73; G06T 2207/10028; G06T 2207/30261

(57) ABSTRACT

A method for detecting based on LiDAR an object around a vehicle which includes a Light Detection and Ranging (LiDAR) sensor includes determining a first object from a point cloud within a detecting range, and determining a heading angle of the first object by a first method, wherein the first method including determining candidate straight lines for the heading angle of the first object, and determining the heading angle of the first object from angles of the candidate straight lines.

### CROSS-REFERENCE TO RELATED APPLICATION

The present application claims priority to Korean Patent Application No. 10-2022-0165894, filed on Dec. 1, 2022, the entire contents of which is incorporated herein for all purposes by this reference.

### BACKGROUND OF THE PRESENT DISCLOSURE

### Field of the Present Disclosure

The present disclosure relates to a method for detecting an object by use of LiDAR and a device thereof.

### Description of Related Art

For safe autonomous driving of a vehicle, a technology capable of accurately recognizing the surrounding environment, i.e., objects around the vehicle, is required.

Accordingly, a vehicle may include various sensor devices such as a camera, a radio detection and ranging (RADAR), and/or a Light Detection and Ranging (LiDAR), and a technology of sensing, tracking, and classifying a surrounding object of the vehicle based on sensor data obtained through the sensor device has been applied to the vehicle.

In detecting an object using LiDAR, sufficient point data for a corresponding object may be secured in the case of a remote object, but when the object is located at a short distance and thus only point data for a part of the object is secured, accurate detection thereof is difficult.

In the case of a vehicle that overtakes the vehicle from the left or right side of the host vehicle or cuts in to the host vehicle driving lane, only a part of the corresponding vehicle is obtained by point, and accordingly, detecting an accurate movement of the corresponding vehicle is difficult.

Because the heading angle of a moving object around a host vehicle is very important in determining the driving route of the host vehicle, the sensing result of the object is required be accurate.

However, as described above, there may be a difference in the LiDAR point data according to the position of a moving object, and thus, applying the same method of determining heading angles to variously positioned moving objects may be problematic.

FIGS. 1A and 1B and FIGS. 2A and 2B illustrate a result of applying a method for determining a heading angle to an adjacent vehicle around a host vehicle, which is separately applied for a patent by the present applicant for determining a heading angle of a moving object located at a relatively long distance.

The example shown in FIG. 1A shows a situation where a vehicle 11 cuts in forward from the right side of the host vehicle 1.

FIG. 1B illustrates point data obtained by the LiDAR sensor of the host vehicle 1 from time frames T−2, T−1, and T for the vehicle 11, and the heading directions determined by the method all appear to be a direction of going straight forward in each of the above-mentioned time frame.

However, it may be understood that the actual heading direction of the vehicle 11, as shown in FIG. 1B, is not a straight forward direction but a direction inclined diagonally toward the front of the subject vehicle 1.

That is, if the method for a long distance object is applied to a short distance object, it may result in that the detected shape 113 is obtained differently from the actual shape 111 of the object as shown in FIG. 1B.

The erroneous result of determining the heading angle is mainly based on that the existing method for determining the heading angle was developed for a case where LiDAR point data may be secured by a range enough to cover a moving object. Therefore, when the LiDAR points are obtained only for a limited portion of the object, using the method results in an incorrect heading angle.

For the vehicle 11 appearing at the lateral edge of the Field of View (FOV) of the LiDAR sensor mounted on the host vehicle 1, point data is obtained only for a portion of the entire shape, and thus there is a limitation in sensing and determining an accurate heading angle using the existing method.

Meanwhile, FIG. 2A as another instance illustrates a situation where a vehicle 21 appears traveling straight forward in the right lane of the host vehicle 1.

Even in the instant case, only a portion of the vehicle 21 appears in the FOV of the sensor of the host vehicle 1, and thus it is difficult to completely identify the shape of the object 21.

When the method is applied as shown in FIG. 2B, the heading angles and the shapes 213 detected for the object 21 based on point data of the LiDAR in time frames T−2, T−1, and T are different from the real ones 211.

Therefore, more accurate heading angle determination method for a vehicle cutting in or overtaking from a close position and the relevant object sensor technology are required, and at least an exemplary embodiment of the present disclosure is directed to aiming at meeting the present requirement.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method for detecting based on LiDAR an object around a vehicle which includes a Light Detection and Ranging (LiDAR) sensor includes determining a first object from a point cloud within a detecting range, and determining a heading angle of the first object by a first method, wherein the first method including determining candidate straight lines for the heading angle of the first object, and determining the heading angle of the first object from angles of the candidate straight lines.

In at least an exemplary embodiment of the present disclosure, the determining of the heading angle of the first object from the angles of the candidate straight lines includes obtaining a weighted sum of the angles of the candidate straight lines.

In at least an exemplary embodiment of the present disclosure, a weight for each candidate straight line is determined according to a length of a corresponding candidate straight line.

In at least an exemplary embodiment of the present disclosure, the weight is determined to be proportional to the length of the corresponding candidate straight line.

In at least an exemplary embodiment of the present disclosure, the candidate straight lines are determined from a plurality of straight lines passing through LiDAR points of the first object or approximate points determined from the LiDAR points.

In at least an exemplary embodiment of the present disclosure, the approximation points are determined from representative points of occupied cells in an approximation grid map for the LiDAR points.

In at least an exemplary embodiment of the present disclosure, a line of a length less than a predetermined length among the plurality of straight lines is removed from the plurality of straight lines.

In at least an exemplary embodiment of the present disclosure, lines overlapping with a rectangle having a predetermined width and a predetermined length among the plurality of straight lines are integrated into one straight line.

In at least an exemplary embodiment of the present disclosure, the LiDAR points of the first object are determined by dividing cloud points for the first object into a plurality of circular sections each including a predetermined azimuth range with respect to an origin of a coordinate system, and extracting a point closest to the origin in each of the circular sections.

In at least an exemplary embodiment of the present disclosure, the detection range include a predetermined area and the first object is determined from the predetermined area.

In at least an exemplary embodiment of the present disclosure, the predetermined area includes a boundary extending from the vehicle in a right or left lateral direction within the detecting range.

In at least an exemplary embodiment of the present disclosure, the boundary matches at least a portion of an edge of a field of view (FOV) of the LiDAR sensor.

In at least an exemplary embodiment of the present disclosure, the predetermined area is defined by a predetermined azimuth angle range from the boundary with respect to an origin of the vehicle or a location of the LiDAR sensor.

In at least an exemplary embodiment of the present disclosure, the method further includes tracking and managing a history of the first object being located in the predetermined area, and determining the heading angle of the first object by the first method for a current time frame in response to the first object including a history located in the predetermined area and located out of the predetermined area in the current time frame.

In at least an exemplary embodiment of the present disclosure, the method further includes determining the heading angle of the first object by a second method for the current time frame in response to the first object located apart from the vehicle by a predetermined or greater distance in the current time frame.

In at least an exemplary embodiment of the present disclosure, the method further includes determining a second object located outside the predetermined area from the point cloud, and determining a heading angle of the second object by a second method.

In at least an exemplary embodiment of the present disclosure, the method further includes determining a shape box for the first object depending on the heading angle.

In at least an exemplary embodiment of the present disclosure, the method further includes determining an initial heading angle and an initial shape information of the first object by a second method and a track of the first object based on the initial heading angle and the initial shape information before determining the heading angle of the first object by the first method, and replacing the initial heading angle with the heading angle determined by the first method and determining shape information of the first object according to the replaced heading angle in response to the first object including a history of being located in a predetermined area within the detecting range.

A non-transitory computer-readable storage medium according to an exemplary embodiment of the present disclosure stores computer program code for performing any of the above-described object sensing methods executed by a computer processor.

Also, a LiDAR-based object detection device according to an exemplary embodiment of the present disclosure includes a LiDAR sensor and a controller which is configured to perform object detection from a point cloud within a detection range obtained by the LiDAR sensor, wherein the object detection is performed by any method described above.

According to an exemplary embodiment of the present disclosure, accurate sensing of the heading angle of a vehicle that comes into the FOV of a LiDAR sensor by cutting in or overtaking is attained.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1A and FIG. 1B and FIG. 2A and FIG. 2B illustrate a result of applying a method for determining a heading angle to an adjacent vehicle around a host vehicle, which is separately applied for a patent by the present applicant.

FIG. 3 illustrates an overall process of object detection according to an exemplary embodiment of the present disclosure.

FIG. 4 shows an object detection device according to an exemplary embodiment of the present disclosure.

FIG. 5 is a flowchart illustrating a process of determining a heading angle and correcting track information by the first method according to an exemplary embodiment of the present disclosure.

FIG. 6 is an exemplary embodiment of step S110 of FIG. 5.

FIG. 7 illustrates the view angles of the left and right LiDAR sensors and a detection range according to an exemplary embodiment of the present disclosure.

FIG. 8 illustrates a process of determining approximation points from LiDAR points of a first object.

FIG. 9A, FIG. 9B and FIG. 9C illustrate a result of determining candidate straight lines according to the resolution of an approximation grid map.

FIG. 10 illustrates an example in which a plurality of candidate straight lines are integrated into one integrated straight line.

FIG. 11A and FIG. 11B illustrate results before and after noise removal and integration with respect to straight lines determined by a Hough transform algorithm.

FIG. 12A, FIG. 12B, FIG. 12C and FIG. 12D show a result of applying the exemplary embodiment to the vehicle 11 of FIG. 1A and FIG. 1B.

FIG. 13 and FIG. 14A and FIG. 14B show the results of applying the object detection method of the exemplary embodiment to a situation where a vehicle cuts in from a right lane and a situation where a vehicle overtakes the host vehicle.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Because the present disclosure may be modified in various ways and have various exemplary embodiments of the present disclosure, specific embodiments will be illustrated and described in the drawings. However, this is not intended to limit the present disclosure to specific embodiments, and it should be understood that the present disclosure includes all modifications, equivalents, and replacements included within the idea and technical scope of the present disclosure.

The suffixes “module” and “unit” used in the present specification are used only for name division between elements, and should not be construed with the premise that they are physically or chemically divided or separated or may be so divided or separated.

Terms including ordinals such as “first”, “second”, etc. may be used to describe various elements, but the elements are not limited by the terms. The terms are used only for distinguishing one element from another component.

The term “and/or” may be used to include any combination of a plurality of items to be included. For example, “A and/or B” includes all three cases such as “A”, “B”, and “A and B”.

When an element is “connected” or “linked” to another component, it is directly connected or linked to that other component, but it should be understood that other elements may exist in between.

The terminology used herein is for describing various exemplary embodiments only and is not intended to be limiting of the present disclosure. Singular expressions include plural expressions, unless the context clearly indicates otherwise. In the present application, it should be understood that the term “include” or “have” indicates that a feature, a number, a step, an operation, a component, a part, or a combination thereof described in the specification is present, but it does not exclude the possibility of existence or addition of one or more other features, numbers, steps, operations, components, parts, or combinations thereof in advance.

Unless defined otherwise, all terms used herein, including technical or scientific terms, include the same meaning as that generally understood by those skilled in the art to which the present disclosure pertains. It will be understood that terms, such as those defined in commonly used dictionaries, should be interpreted as having a meaning which is consistent with their meaning in the context of the relevant art and will not be interpreted in an idealized or overly formal sense unless expressly so defined herein.

Furthermore, the unit or the control unit is a term widely used in defining a controller configured for controlling a vehicle specific function, and does not mean a generic function unit. For example, each unit or control unit may include a communication device communicating with another controller or sensor to control a function in charge, a memory storing an operating system or a logic command, input/output information, and the like, and one or more processors performing determination, operation, determination, etc., necessary for controlling a function in charge.

Hereinafter, various embodiments of the present disclosure will be described in detail with reference to the drawings.

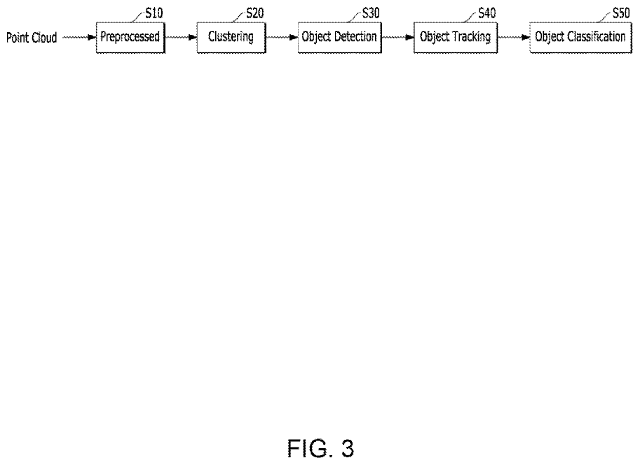

FIG. 3 illustrates an overall process of a method for detecting an object according to an exemplary embodiment of the present disclosure, and as illustrated, includes point cloud acquisition using a LiDAR sensor, preprocessing, clustering, object detection, object tracking, and object classification.

The LiDAR sensor used to obtain the point cloud may detect information related to an object, such as a distance, a direction, a speed, a temperature, a material characteristic of the object, by projecting a single circular laser pulse including a predetermined wavelength to the object, and then measuring a returning time of the laser pulse reflected from the object within a measurement range.

Here, the object may be another vehicle, a person, an object, or the like existing outside a host vehicle in which the LiDAR sensor is mounted, but the exemplary embodiment of the present disclosure is not limited to a specific type of the object.

The LiDAR sensor may include a transmitter that transmits a laser pulse, and a receiver that receives a laser reflected from a surface of an object existing within a sensor range.

The LiDAR sensor includes a Field of View (FOV), which is an area which may be observed, and the FOV may vary according to the type or performance of the LiDAR sensor.

The LiDAR sensor may include a two-dimensional (2D) LiDAR sensor and/or a three-dimensional LiDAR sensor.

The 2D LiDAR sensor has only a horizontal FOV and the 3D LiDAR sensor includes a horizontal FOV and a vertical FOV.

The 3D LiDAR sensor can obtain a large number of three-dimensional points, so it can predict even the height information of an object, assisting to detect or track the object in an accurate and detailed manner. The 3D LiDAR sensor may include a plurality of 2D LiDAR sensors vertically provided for a plurality of channels to generate LiDAR data with 3D information.

Also, a 2D point cloud may be obtained by projecting a 3D point cloud data obtained by the 3D LiDAR sensor onto a 2D plane or by only using the data of one predetermined channel.

The object detecting method and device according to the exemplary embodiment of the present disclosure are not limited to a specific shape, position, and type of the LiDAR sensor.

Point data obtained by the LiDAR sensor is pre-processed (S10).

In the preprocessing, a calibration process may be performed in which the LiDAR data are transformed from a coordinate system of the LiDAR sensor to a reference coordinate system, e.g., a vehicle coordinate system which includes the origin on the center portion of the front bumper of the vehicle, according to the position and the angle at which the LiDAR sensor is mounted on the host vehicle.

Also, through preprocessing, data including low intensity or reflectance may be removed through filtering based on intensity or confidence information of the LiDAR data.

Furthermore, through the preprocessing, data reflected by the body of the host vehicle may also be removed.

Noise and unnecessary data are removed through preprocessing, and only valid point cloud data remains, and clustering is performed (S20).

The clustering is a process of clustering point cloud data through a predetermined clustering algorithm, and the algorithm used at the instant time may be, for example, a K-means or Hierarchical clustering algorithm.

Preferably, LiDAR points belonging to each individual object are grouped into one group. That is, for example, other vehicles around the host vehicle are grouped as one moving object.

Next, object detection is performed on the clustered data (S30).

In the object detection, a box (hereinafter, referred to as a “shape box”) may be generated by fitting a clustered shape, and a heading angle, a width, and a length of a corresponding cluster object may be determined depending on the shape box.

Before determining the shape box in the present example, representative points may be extracted from LiDAR points belonging to one cluster, i.e., one object, and contour points may be extracted from the representative points. A method of determining the representative points and the contour points is described in Korean Patent Application Publication No. 10-2021-0124789 filed by the present applicant, and related portions are considered to be included in the present specification, and a detailed description thereof will be omitted.

The representative points of an object may be determined among the cloud points thereof by dividing the cloud points into a plurality of circular sections each including a predetermined azimuth range with respect to an origin of a coordinate system (e.g., the vehicle coordinate system), and extracting a point closest to the origin in each of the circular sections.

The shape box of the object may be determined as a rectangular box in which the external points are fitted, and when the rectangular box is determined, the width, length, and heading angle thereof may be determined as shape data of the corresponding object.

Here, a method of determining the heading angle (referred to as the “second method” to distinguish from the later-described first method) will be described in more detail.

The second method finally is configured to determine that a result value obtained by adding the shortest distances from each external point to an edge of a corresponding bounding box with respect to each of several boxes (for convenience, referred to as “bounding boxes”) fitted to surround contour points extracted by the above-described method is minimized, is configured to determine the determined bounding box as a shape box of a corresponding object, is configured to determine the heading angle of the corresponding object from an inclination angle of the box, and is configured to determine the width and length of the corresponding object from the width and length of the box.

Next, object tracking proceeds based on the shape box determined in the object detection (S40). In the object tracking, a track for a corresponding object is determined. For example, matching property with an existing track which is already generated for each shape box and is tracked and managed up to a previous time frame is evaluated, and when a shape box of a current time frame matches the existing track, the corresponding track is updated through information in the current time frame of the corresponding object.

In the instant case, when there is no existing track to be matched, a track for the corresponding object may be generated in the current time frame and is tracked and managed according to time after generation.

Here, the track may be a set of temporal data for continuously tracking and managing a detection result of the corresponding object. For example, the track may include a set of detection results obtained for each time frame with respect to a plurality of time frames.

For example, in an exemplary embodiment of the present disclosure, the track may include shape information such as a position, a speed, a width, and a length of the corresponding object, a heading angle, etc.

Also, the track may include a history in which the corresponding object is located in a later-described predetermined area in a detection range of the LiDAR sensor.

Here, the track may not be based on one sensor data, but it may be based on data obtained from several heterogeneous sensors, i.e., sensor fusion data. For example, a sensor fusion technology using sensors such as a LiDAR sensor, a camera, and a radar may be used.

Next, object classification is performed (S50).

In the object classification, the classification to which the corresponding object belongs is determined based on the detection result of the corresponding object.

For example, the detected object is classified as one of a person, a passenger vehicle, a two-wheeled vehicle, a commercial vehicle, and the like based on the detection data.

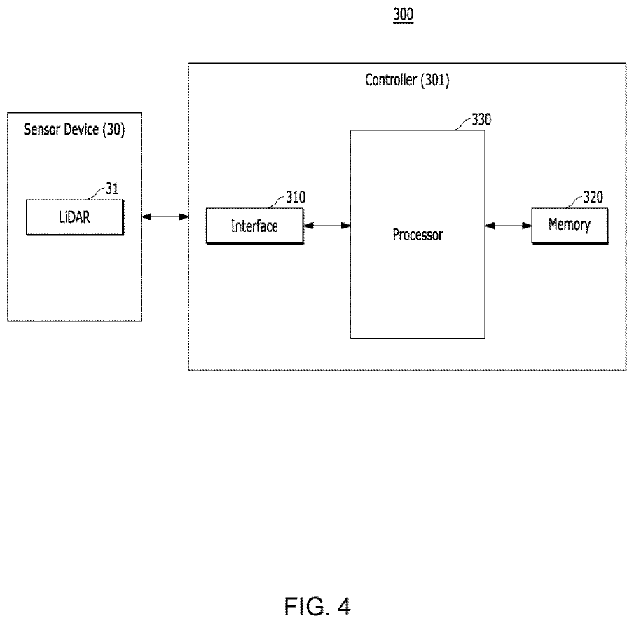

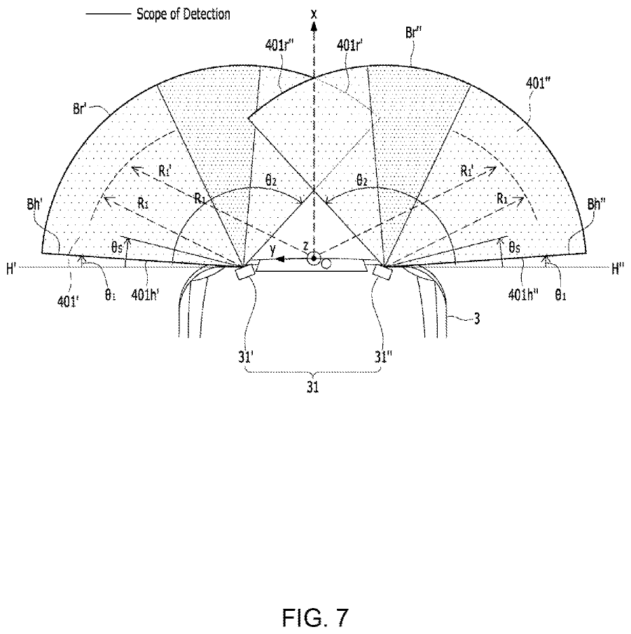

FIG. 4 is a block drawing of an object sensing device according to an exemplary embodiment of the present disclosure, and FIG. 7 is a view for explaining a viewing angle of a LiDAR according to an exemplary embodiment of the present disclosure.

Referring to FIG. 4, the object sensor device 300 may include a sensor device 30 and a controller 301.

The sensor device 30 may include one or more sensors configured for obtaining information related to an object located in the periphery of the object detection device 300, and may include the LiDAR sensor 31 in an exemplary embodiment of the present disclosure.

The LiDAR sensor 31 may be one or a plurality of LiDAR sensors, and may be configured to generate LiDAR data, that is, point cloud data by projecting a laser pulse toward the periphery of the object detection device 300.

For example, referring to FIG. 7, the LiDAR sensor 31 may include a left LiDAR 31′ provided at the front left side of the object detection device 300 and a right LiDAR 31″ provided at the front right side of the vehicle.

The LiDAR sensor 31 includes a field of view (FOV), and illustratively, as shown in FIG. 7, the left LiDAR 31′ includes a left LiDAR FOV 401′ and the right LiDAR 31″ includes a right LiDAR FOV 401″.

The viewing angle means an area which may be observed by the LiDAR sensor, and is generally expressed as an angle. For example, in FIG. 7, the FOVs 401′ and 401″ of the left LiDAR 31′ and the right LiDAR 31″ are “θ2-θ1”, respectively.

In an exemplary embodiment of the present disclosure, the FOV 401′ of the left LiDAR 31′ and the FOV 401″ of the right LiDAR 31″ are the same, but are not necessarily limited thereto.

As shown in FIG. 7, the right LiDAR 31″ is provided to face the right diagonal direction, and the right horizontal boundary 401h″ thereof is provided to include a predetermined angle θ1 in the counterclockwise direction from the right horizontal line H″. Furthermore, the left LiDAR 31′ is provided to face the left oblique direction, and is provided so that the left horizontal boundary 401h′ thereof includes a predetermined angle θ1 in the clockwise direction from the left horizontal line H′.

For convenience, as shown in FIG. 7, the center portion of the front bumper of the host vehicle 3 is defined as the origin point o, the straight direction of the host vehicle 3 is defined as the x-axis, the left straight direction is defined as the y-axis, and the direction from the ground to the sky is defined as the z-axis. The horizontal lines H′ and H″ described above refer to straight lines parallel to the y-axial direction in FIG. 7.

In the exemplary embodiment of the present disclosure, as shown in FIG. 7, the detection range by the LiDAR is determined by the FOV 401′ of the left LiDAR 31′ and the FOV 401″ of the right LiDAR 31″. That is, in an exemplary embodiment of the present disclosure, the detection range is determined by the integrated FOVs of the left LiDAR 31′ and the right LiDAR 31″.

As shown in FIG. 7, the detection range is defined by a left horizontal boundary Bh′ and a right horizontal boundary Bh″, and a left radial boundary Br′ and a right radial boundary Br″.

Here, the left horizontal boundary Bh′ and the right horizontal boundary Bh″ of the detection range coincide with the left horizontal boundary 401h′ of the left LiDAR 31′ and the right horizontal boundary 401h″ of the right LiDAR 31″, respectively.

Furthermore, the left radial boundary Br′ and the right radial boundary Br″ of the detection range coincide with a portion of the left radial boundary 401r′ of the left LiDAR 31′ and a portion of the right radial boundary 401r″ of the right LiDAR 31″, respectively.

Although two LiDAR sensors 31′ and 31″ are used in an exemplary embodiment of the present disclosure, the present disclosure is not limited thereto, and the number of LiDAR sensors used may be changed depending on the selection of a detection range around the vehicle or FOV characteristics of the LiDAR sensors.

Furthermore, in an exemplary embodiment of the present disclosure, the detection range is determined by the integrated FOV of the two LiDAR sensors 31′ and 31″, but is not limited thereto. That is, the detection range does not necessarily match the FOV of the LiDAR sensor and may be determined according to design requirements within the FOV range.

Meanwhile, although not shown, the sensor device 30 may further include a radar and/or a camera configured for detecting objects around the host vehicle 3.

The controller 301 of the object detection device 300 includes an interface 310, a memory, and the like. The system may include a memory 320 and a processor 330.

Herein, in an exemplary embodiment of the present disclosure, the memory 320 and the processor 330 may be implemented as separate semiconductor circuits. Alternatively, the memory 320 and the processor 330 may be implemented as a single integrated semiconductor circuit. The processor 330 may embody one or more processor(s).

The interface 310 transmits a command or data input from the sensor device 30 and/or a vehicle control device of the object detection device 300 or a user to the controller 301 or transmits data of the controller 301 to another device (for example, a vehicle control device) as output thereof.

The interface 310 may include a communication module for input and output of data.

For example, the communication module may include Controller Area Network (CAN) communication and/or Local Interconnect Network (LIN) communication. Furthermore, the communication module may include a wired communication module (e.g., a power line communication module) and/or a wireless communication module (e.g., a cellular communication module, a Wi-Fi communication module, a short-range wireless communication module, and/or a global navigation satellite system (GNSS) communication module).

The memory 320 may store various data, i.e., input data and/or output data for a software program and commands related thereto.

For example, the memory 320 may store a computer program for performing the object detecting method according to an exemplary embodiment of the present disclosure. The computer program includes computer instructions for performing the object sensing method as called and executed by the processor 330.

For example, the computer program may include a computer algorithm, a clustering algorithm, an object detection algorithm, an object tracking algorithm, an object classification algorithm, and the like for performing the above-described preprocessing.

The memory 320 may include a cache, a Read Only Memory (ROM), a Programmable ROM (PROM), an Erasable Programmable ROM (EPROM), and an Electrically Erasable (EEPROM) the non-volatile memory may include a Programmable ROM, a non-volatile memory such as a flash memory, and/or a volatile memory such as a random access memory (RAM).

The processor 330 may be configured for controlling at least one other feature element (i.e., the interface 310 and/or the memory 320) of the controller 301, and may perform data processing, calculation and determination corresponding to each of the above-described algorithms.

The processor 330 may receive sensing data from the sensor device 30 through the interface 310, for example, point data from the LiDAR sensor 31, and execute the above-described algorithm.

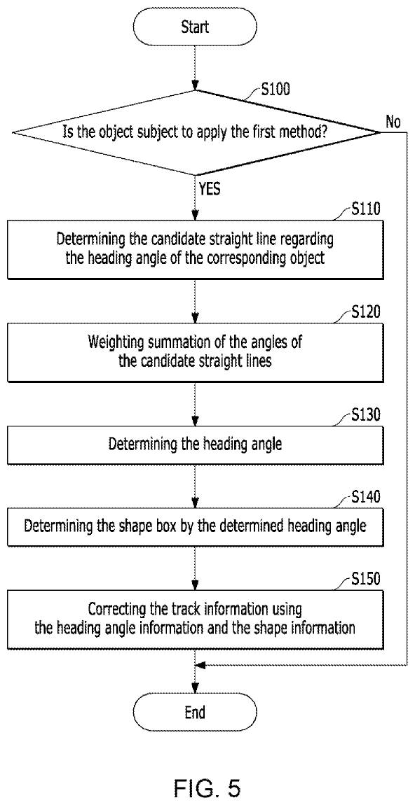

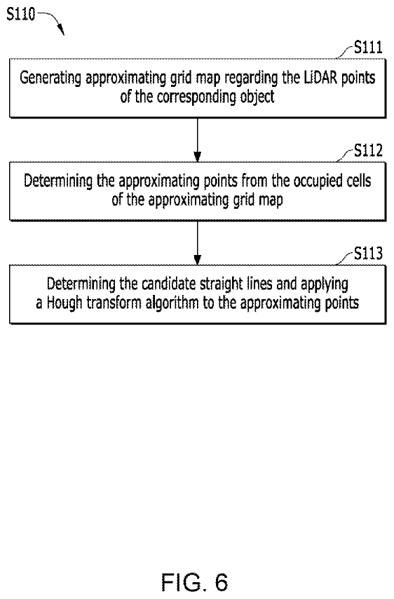

In an exemplary embodiment of the present disclosure, when the object tracking step described above is performed or completed in the current time frame, the heading angle of the object is determined again by the first method, which will be described in detail with reference to FIG. 5 and FIG. 6.

Referring to FIG. 5, first, a target object to which the first method is applied is determined (S100).

In an exemplary embodiment of the present disclosure, to determine the object to apply the first method, a predetermined area is defined with respect to the above-mentioned sensing and will be explained first.

Referring to FIG. 7, the predetermined area may be defined as a predetermined azimuth range “θs-θ1” in a clockwise direction from the left horizontal boundary 401h′, and may be defined as a predetermined azimuth range “θs-θ1” in a counterclockwise direction from the right horizontal boundary 401h″.

In an exemplary embodiment of the present disclosure, the left predetermined area and the right predetermined area are the same, but are not limited thereto.

In an exemplary embodiment of the present disclosure, the left predetermined area is defined to be suitable for detecting another vehicle passing or cutting in the left lane of the host vehicle 3, and the right predetermined area is defined to be suitable for detecting another vehicle overtaking or cutting in the right lane of the subject vehicle 3, but is not limited thereto.

As an exemplary embodiment of the present disclosure, the predetermined area may be defined to apply the determination of the heading angle by the first method to a more suitable moving object than the determination of the heading angle by the second method, and the predetermined area may be defined differently from the exemplary embodiment if it is the predetermined area.

In an exemplary embodiment of the present disclosure, an object to which the first method is to be applied (hereinafter, referred to as a “first object” for convenience) is determined based on the above-described predetermined area (S100).

For example, an object located in a predetermined area in the current time frame may be determined as the first object.

Alternatively, additionally or alternatively to the above determination method, an object including a history located in the predetermined area may be determined as the first object.

In the object tracking step for each object, a track for the current time frame is determined (updated or newly generated), and history information in which the corresponding object is located in a predetermined area may be obtained from the track information.

That is, in an exemplary embodiment of the present disclosure, the first object may be defined as an object which is located in the predetermined area in the current time frame or that includes a history that has been located in the predetermined area from the track information.

Furthermore, here, the fact that the first object is located in the predetermined area, as an exemplary embodiment of the present invention, means that at least one portion of the shape box determined while determining a heading angle (hereinafter, referred to as an “initial heading angle” for convenience) by at least some of the LiDAR points of the first object or the second method overlaps the predetermined area.

Furthermore, when the corresponding object is located outside the predetermined area in the current time frame but includes a history located in the predetermined area in the past time frame, the corresponding object may be determined as the first object when the corresponding object is located within the predetermined distance range from the user vehicle 3.

For example, referring to FIG. 7, the predetermined distance range may be a range within a predetermined distance R1′ from the origin o of the subject vehicle 3, or may be a range within a predetermined distance R1 with respect to the LiDAR sensor 31.

In the case of an object appearing near to the FOV edge, since only the LiDAR point for the portion of the object (a portion located within an FOV or a detection range) is obtained, it is hard to exclude incomplete LiDAR data, and there may be a range limitation of a defined predetermined area. To handle this, even if the current time frame is out of the predetermined area, if there is a history located in the predetermined area in the past time frame, the first method is applied, but if the current time frame is out of the predetermined distance, the current time frame is excluded from the predetermined area because there is a high probability that the current time frame is not a proximate object. Here, when the corresponding object is no longer the first object, the heading angle determination according to the second method may be maintained.

After the first object is determined, a heading angle is determined by the first method, which will be described below.

First, candidate straight lines are determined with respect to the first object (S110). The candidate straight lines are straight lines related to the heading angle of the first object, and the LiDAR points of the first object may be determined using the LiDAR points or the approximation points thereof, as explained below.

Because the above-described representative points are determined as the object selected as the first object, candidate straight lines may be determined using the above-described representative points. However, the exemplary embodiment of the present disclosure is not limited to using representative points in determining the candidate straight lines of the first object, and raw data obtained from the LiDAR sensor may be used as long as limitations on calculation cost and time are allowed.

Here, illustratively, the LiDAR points of the first object are two-dimensional data distributed on an x-y plane or a plane parallel to the x-y plane. For example, the LiDAR sensor 31 may obtain data through a plurality of channels divided according to the height in the z direction, and the 2D LiDAR point data may be obtained by projecting LiDAR points included in all or some of the channels onto a plane parallel to the x-y plane or the x-y plane.

Although the above-described representative points may be used to determine the candidate straight lines, to reduce the amount of computation, the approximation points may be determined and the approximation points may be used.

The candidate straight lines may be determined from the representative points or straight lines passing through the approximation points, and for the present purpose, a well-known Hough transform algorithm may be used.

FIG. 6 is a flowchart illustrating a process of determining approximate points and a process of determining candidate straight lines by applying a Hough transform algorithm to the approximate points, which will be described in detail.

First, an approximation grid map for LiDAR points of the first object is generated (S111), and approximation points are determined from the generated approximation grid map (S112).

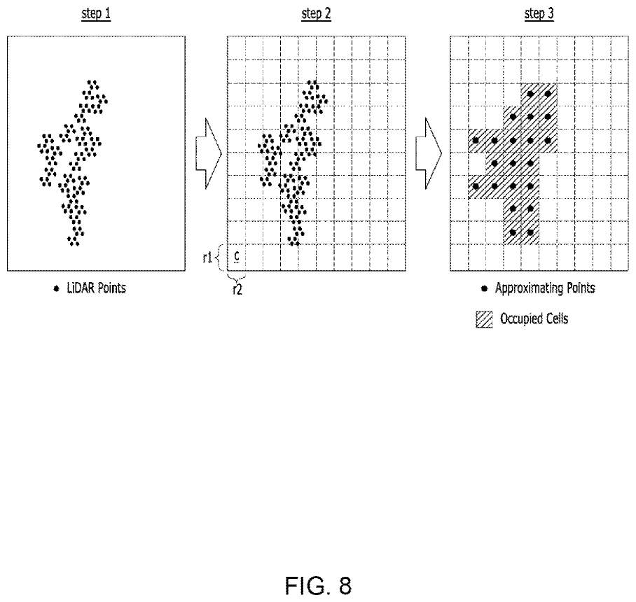

FIG. 8 illustrates a process of assuming LiDAR points of the first object and determining the approximation points.

Referring to FIG. 8, an approximation grid map is generated by mapping LiDAR points (step 1) of a first object to an approximation grid (step 2) (step 3).

Here, the cell shape of the grid is a quadrangle, but it is not necessarily limited thereto, and may be of another shape.

An occupied cell occupied by LiDAR points of the first object is determined from the approximation grid map, and a representative point representing the occupied cell may be determined from each occupied cell.

As shown in FIG. 8, the representative point of the occupied cell may be, for example, a center point of the occupied cell, but is not limited thereto, and may be an arbitrary, virtual point position in the occupied cell.

When the representative points of the occupied cell are determined, approximation points of the first object are determined therefrom.

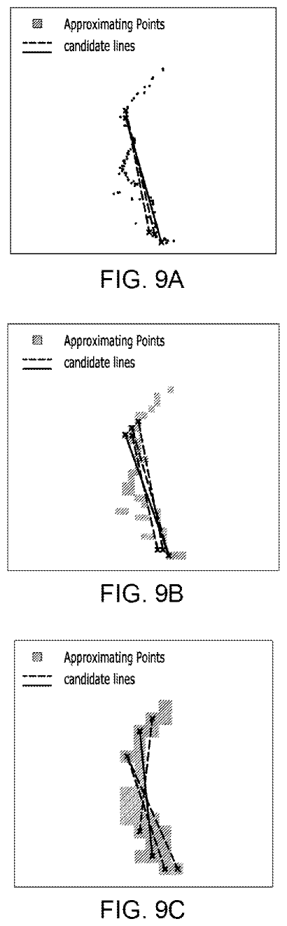

In the approximated grid map, the sizes r1 and r2 of the grid cells c (here, in an exemplary embodiment of the present disclosure, r1 and r2 may be of the same value), that is, the resolution of the approximated grid map may be too small, the calculation cost and time may be increased, and when the resolution is too large, the accuracy of the heading angle determination described below may be decreased due to the excessive approximation. This will be described in detail with reference to FIG. 9A, FIG. 9B and FIG. 9C.

First, FIG. 9A, FIG. 9B and FIG. 9C shows a simulation result of the heading angle determination of the exemplary embodiment according to the resolution of the approximation grid map.

FIG. 9A, FIG. 9B and FIG. 9C show grid map results of different resolutions, and the resolution of FIG. 9A is set to be higher than the resolution of FIG. 9B, and the resolution of FIG. 9C is set to be lower than the resolution of FIG. 9B.

The grid map generated with a high resolution as shown in FIG. 9A may produce a result similar to a case of actually using the LiDAR point, but it includes a disadvantage in that an excessive calculation time is required.

Furthermore, when the resolution is low as shown in FIG. 9C, there is a possibility that candidate straight lines far from the actual LiDAR point due to excessive approximation are extracted.

FIG. 9B shows a case in which an appropriate level of resolution is determined through many trials and errors regarding the size of a grid cell, and it may be seen that straight lines approximate to the straight lines of FIG. 9A are extracted while the operation time of the processor is significantly reduced compared to FIG. 9A.

Therefore, the approximate grid map generation needs to determine the resolution in consideration of the calculation time of the processor and the reliability of the extracted straight lines.

A Hough transform algorithm may be used to determine straight lines passing through approximation points, and candidate straight lines with respect to a heading angle may be determined from the straight lines (S113).

In the case of another vehicle appearing in the predetermined area adjacent to the vehicle direction 3, LiDAR points by a side mirror, an inclined wheel, and the like may be included as a portion of the front portion of the corresponding vehicle. The candidate straight line determined from the LiDAR points by the side mirror, the inclined wheel, or the like, is an obstacle to determining a heading angle of the corresponding object, and thus, it is necessary to remove the candidate straight line.

In an exemplary embodiment of the present disclosure for the present purpose, the straight lines including a length equal to or less than the set length are removed.

Furthermore, among the candidate straight lines, straight lines including a slope close to that of the candidate straight lines may be integrated into one straight line.

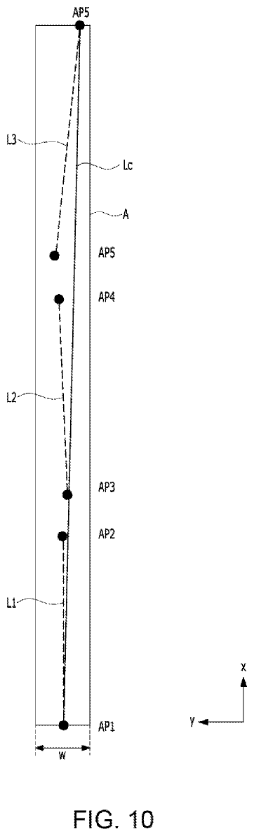

To the present end, as shown in FIG. 10, straight lines L1, L2, and L3 extending from an arbitrary straight line L1 and overlapping an virtual rectangle A having a predetermined width w are integrated into one straight line Lc.

In the instant case, the integrated straight line Lc may be obtained by connecting the points API and AP6 including the minimum x-axis coordinate value and the maximum x-axis coordinate value of the points API to AP6 of the corresponding straight lines L1, L2, and L3.

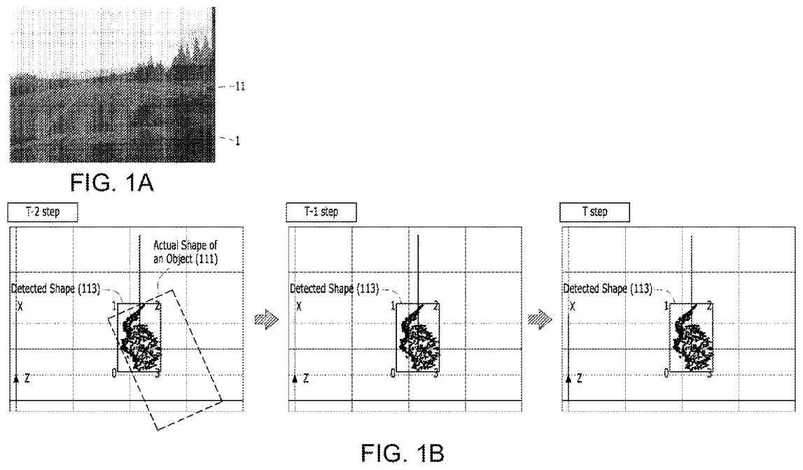

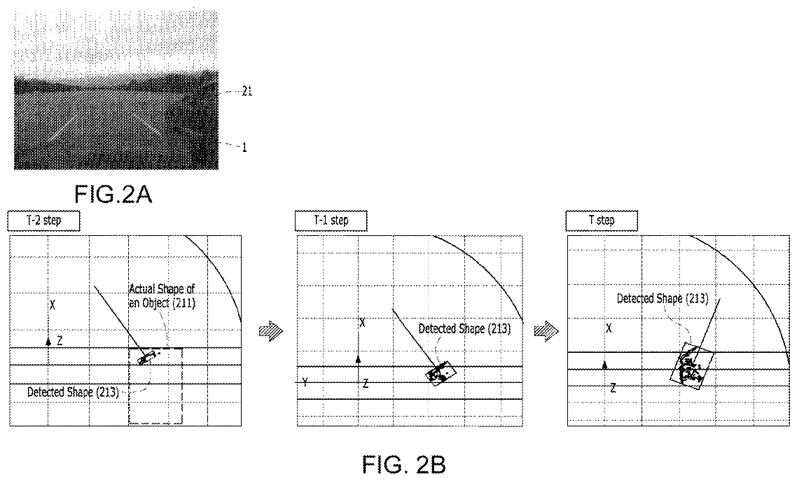

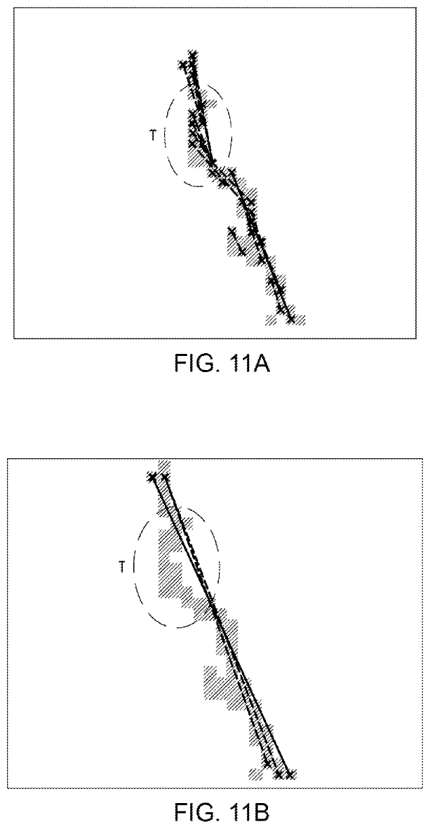

FIG. 11A and FIG. 11B illustrate a result of applying the removal of noise straight lines and the straight line integration to the other vehicle 11 of FIG. 1 as described above.

FIG. 11A shows a result before noise straight line removal and straight line integration are applied, and FIG. 11B shows a result after the application.

In FIG. 11A and FIG. 11B, a portion indicated by “T” indicates a portion of a tire protruding out of the vehicle body at a steering angle in the other vehicle 11, and since the steering direction of the tire is different from the heading direction of the vehicle body, the portion may be excluded when determining the heading angle of the other vehicle 11.

As shown in FIG. 11A, it may be observed that before noise removal and integration with respect to the straight lines, the straight lines by the tire portion are considerably included in FIG. 11A.

However, when the above-described noise removal and straight line integration are performed, as shown in FIG. 11B, it may be seen that the straight lines by the tire are removed.

Referring back to FIG. 5, when candidate straight lines with respect to the heading angle of the first object are determined, weighting summation is performed with respect to inclination angles (i.e., heading angles of respective straight lines) of the candidate straight lines (S120).

For example, when it is assumed that five candidate straight lines CL1, CL2, CL3, CL4 and CL5 are determined with respect to a predetermined first object, the heading angle α of the first object may be determined by Equation 1 below.

$$α ∝ ω 1 \cdot α 1 + ω 2 \cdot α 2 + ω 3 \cdot α 3 + ω 4 \cdot α 4 + ω 5 \cdot α 5 \qquad [ Equation 1 ]$$

(Here, α1 denotes a heading angle of CL1, α2 denotes a heading angle of CL2, α3 denotes a heading angle of CL3, α4 denotes a heading angle of CL4, α5 denotes a heading angle of CL5, ω1 denotes a weight of CL1, ω2 denotes a weight of CL2, ω3 denotes a weight of CL3, ω4 denotes a weight of CL4, and ω5 denotes a weight of CL5.)

In the above equation, the weight of each candidate straight line may be determined to be proportional to the length of the corresponding straight line. Accordingly, it was confirmed through experiments that the longer the length of the corresponding straight line, the greater the contribution of the first object to the heading angle determination, and thus the weight determination is effective for determination of accurate heading angle.

That is, the weight of each candidate straight line may be determined by Equation 2 below

$${ω}_{i} = \frac{{ℓ}_{i}}{{\sum }_{i = 1}^{5} {ℓ}_{i}} \qquad [ Equation 2 ]$$

(Here, [symbol] i denotes the length of the i-th candidate straight line)

When the heading angle of the first object is determined according to the first method (S130), a bounding box surrounding the representative points of the first object is determined with the heading angle information. Although the heading angle is determined in a process of determining the bounding box corresponding to the shape box of the corresponding object at the time of determining the initial heading angle by the second method described above, the bounding box corresponding to the shape box of the corresponding object is determined using the heading angle information.

When the bounding box is newly determined as described above, the box may be determined again as the shape box of the corresponding object (S140).

Furthermore, the width and length of the corresponding object are again determined depending on a new determination of the shape box.

The newly determined heading angle, shape box, and shape information of the first object are used to update track information of the corresponding object (S150). That is, in the track of the corresponding object, the initial heading angle and the shape information determined at that time are updated to newly determined information.

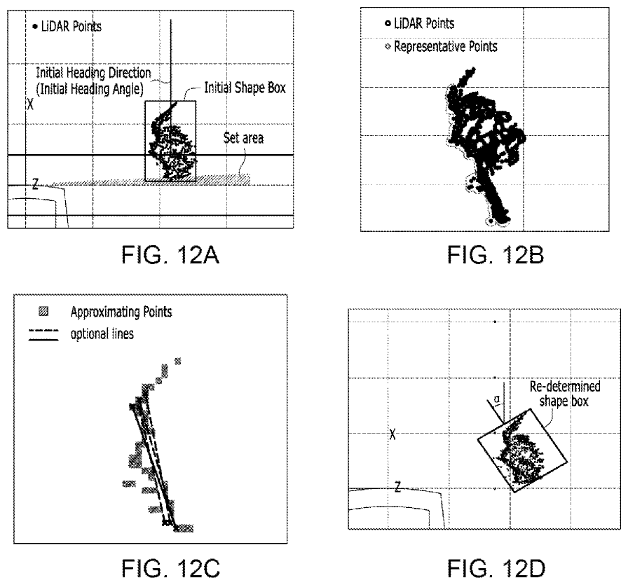

FIG. 12A, FIG. 12B, FIG. 12C and FIG. 12D illustrates a result in which a heading angle is determined for the other vehicle 11 in the situation of FIG. 1A and FIG. 1B according to the exemplary embodiment of the present disclosure.

First, FIG. 12A shows the initial heading angle of the other vehicle 11 and the shape box thereof, which are determined in the above-described object detection.

As shown in FIG. 12A, since the LiDAR point of the other vehicle 11 or the shape box thereof partially overlaps the predetermined area, even though the heading angle and the shape box have already been determined, the LiDAR point or the shape box is determined as the first object to which the first method is applied in the above-described object tracking.

FIG. 12B shows representative points determined according to the method described above from the LiDAR points of FIG. 12A.

For the application of the first method, as shown in FIG. 12C, approximation points are determined through the above-described approximation grid map for the representative points of FIG. 12B, and candidate straight lines are determined by applying a Hough transform algorithm to the approximation points.

By applying Equations 1 and 2 to the candidate straight lines determined as described above, a heading angle α is newly determined as shown in FIG. 12D. Accordingly, the shape box is newly determined using the newly determined heading angle α, and the track information of the other vehicle 11 is updated with the newly determined values.

Here, the track may be a sensor fusion track including sensing information based on a camera and a radar as well as a LiDAR.

According to the above-described embodiments, the host vehicle 3 may improve detection performance for heading information and shape information of an object in which an incomplete shape is detected in an ultra-close region, for example, an FOV edge region of the LiDAR sensor 31. Accordingly, the host vehicle 3 may perform sophisticated control corresponding to the corresponding object through accurate recognition of the object cutting in or overtaking at the surrounding short distance.

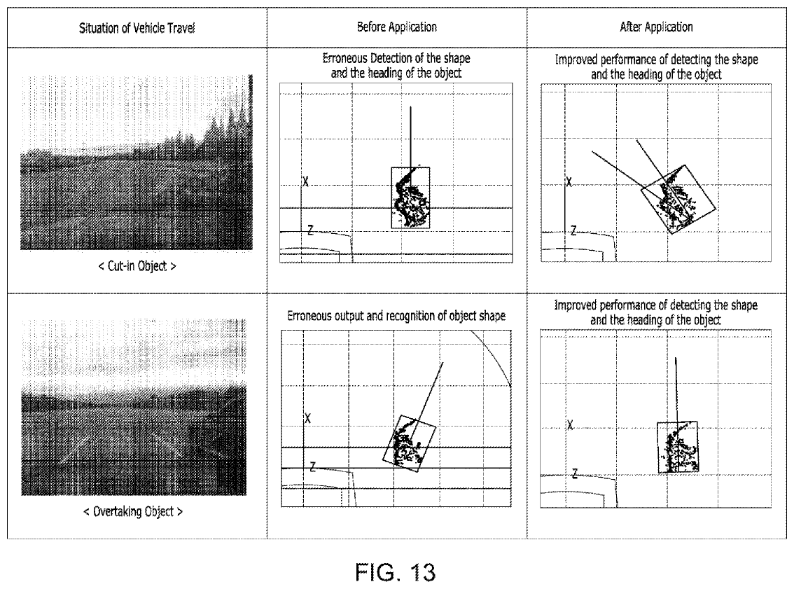

FIG. 13 shows detection results before and after the application of the technology according to the exemplary embodiment with respect to a situation where another vehicle driving on the right lane of the host vehicle 3 cuts in the direction of the host vehicle (the same as the situation of FIG. 1) and a situation where the other vehicle overtakes straight in the right lane.

As shown in FIG. 13, before the technology according to the exemplary embodiment of the present disclosure is applied, there is a problem of incorrectly detecting the heading and shape of an object. However, it may be seen that the heading and shape detection performance of the object is improved after applying the technique according to the exemplary embodiment of the present disclosure.

After applying the technique according to an exemplary embodiment of the present disclosure as shown in FIG. 13, it may be confirmed that a heading angle close to an actual heading direction of the other vehicle is detected.

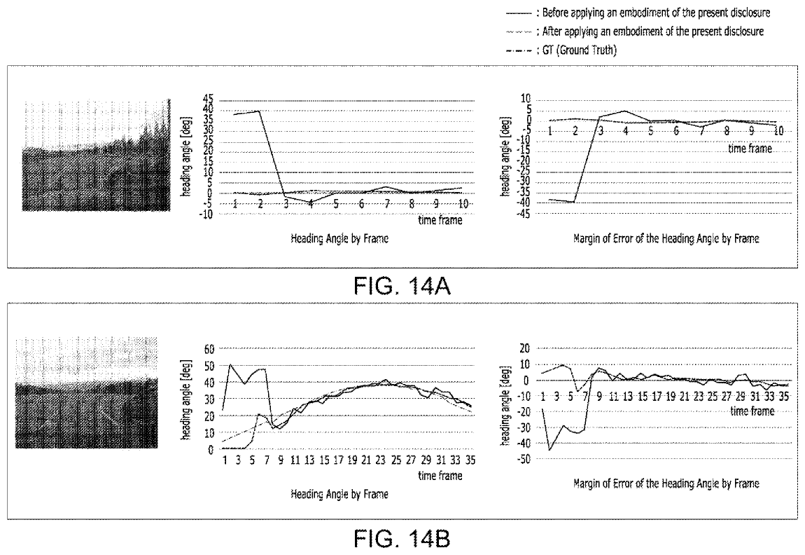

FIG. 14A and FIG. 14B illustrate a result of detecting the heading angle for each time frame, which is divided into a case before and a case after the exemplary embodiment of the present disclosure is applied to each situation of FIG. 13.

FIG. 14A illustrates a cut-in situation, and a first graph shows a result of detecting a heading angle for each time frame with respect to another vehicle together with an actual heading angle GT, and shows that a third graph shows a heading error for each time frame.

FIG. 14B illustrates an overtaking situation, wherein the first graph shows a result of detecting a heading angle for each time frame, and the second graph shows a heading error difference for each time frame.

Referring to the graphs shown in FIG. 14A and FIG. 14B, it may be seen that the performance of detecting the heading angle of the other vehicle is improved according to the technical application of the exemplary embodiment of the present disclosure.

In the above-described embodiment, the determination of the heading angle by the first method is referred to as being performed in the object tracking step, but it is not limited thereto. It is evident that the performing step of determining the heading angle by the first method may be appropriately selected according to design requirements.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for detecting, based on Light Detection and Ranging (LiDAR), an object around a vehicle which includes a LiDAR sensor, the method comprising:
determining, by a controller, a first object from a point cloud within a detecting range; and
determining, by the controller, a heading angle of the first object by a first method,
wherein the first method including:
determining, by the controller, candidate straight lines for the heading angle of the first object; and
determining, by the controller, the heading angle of the first object from angles of the candidate straight lines.

2. The method of claim 1, wherein the determining of the heading angle of the first object from the angles of the candidate straight lines includes obtaining a weighted sum of the angles of the candidate straight lines.

3. The method of claim 2, wherein a weight for each candidate straight line is determined according to a length of a corresponding candidate straight line.

4. The method of claim 3, wherein the weight is determined to be proportional to the length of the corresponding candidate straight line.

5. The method of claim 1, wherein the candidate straight lines are determined from a plurality of straight lines passing through LiDAR points of the first object or approximate points determined from the LiDAR points.

6. The method of claim 5, wherein the approximation points are determined from representative points of occupied cells in an approximation grid map for the LiDAR points.

7. The method of claim 5, wherein a line of a length less than a predetermined length among the plurality of straight lines is removed from the plurality of straight lines.

8. The method of claim 5, wherein lines overlapping with a rectangle having a predetermined width and a predetermined length among the plurality of straight lines are integrated into one straight line.

9. The method of claim 5, wherein the LiDAR points of the first object are determined by dividing cloud points for the first object into a plurality of circular sections each including a predetermined azimuth range with respect to an origin of a coordinate system, and extracting a point closest to the origin in each of the circular sections.

10. The method of claim 1, wherein the detection range include a predetermined area and the first object is determined from the predetermined area.

11. The method of claim 10, wherein the predetermined area includes a boundary extending from the vehicle in a right or left lateral direction within the detecting range.

12. The method of claim 11, wherein the boundary matches at least a portion of an edge of a field of view (FOV) of the LiDAR sensor.

13. The method of claim 11, wherein the predetermined area is defined by a predetermined azimuth angle range from the boundary with respect to an origin of the vehicle or a location of the LiDAR sensor.

14. The method of claim 10, further including:
tracking and managing, by the controller, a history of the first object being located in the predetermined area; and
determining, by the controller, the heading angle of the first object by the first method for a current time frame in response to the first object including a history located in the predetermined area and located out of the predetermined area in the current time frame.

15. The method of claim 14, further including determining, by the controller, the heading angle of the first object by a second method for the current time frame in response to the first object located apart from the vehicle by a predetermined or greater distance in the current time frame, wherein the second method includes:
determining a bounding box which has a minimal result value obtained by adding shortest distances from each external point to an edge of the bounding box among a plurality of predetermined bounding boxes fitted to surround contour points of the first object as a shape box for the first object; and
determining a heading angle of the first object from an inclination angle of the bounding box.

16. The method of claim 10, further including:
determining, by the controller, a second object located outside the predetermined area from the point cloud; and
determining, by the controller, a heading angle of the second object by a second method,
wherein the second method includes:
determining a bounding box which has a minimal result value obtained by adding shortest distances from each external point to an edge of the bounding box among a plurality of predetermined bounding boxes fitted to surround contour points of the first object as a shape box for the first object; and
determining a heading angle of the first object from an inclination angle of the bounding box.

17. The method of claim 1, further including determining a shape box for the first object depending on the heading angle.

18. The method of claim 1, further including:
before determining the heading angle of the first object by the first method, determining an initial heading angle and an initial shape information of the first object by a second method and determining a track of the first object based on the initial heading angle and the initial shape information; and
in response to the first object including a history of being located in a predetermined area within the detecting range, replacing the initial heading angle with the heading angle determined by the first method and determining shape information of the first object according to the replaced heading angle,
wherein the second method includes:
determining a bounding box which has a minimal result value obtained by adding shortest distances from each external point to an edge of the bounding box among a plurality of predetermined bounding boxes fitted to surround contour points of the first object as a shape box for the first object; and
determining a heading angle of the first object from an inclination angle of the bounding box.

19. A non-transitory computer-readable storage medium storing a computer program code which is configured to perform a method when executed by a computer processor, the method comprising:
determining a first object from a point cloud within a detecting range; and
determining a heading angle of the first object by a first method,
wherein the first method including:
determining candidate straight lines for the heading angle of the first object; and
determining the heading angle of the first object from angles of the candidate straight lines.

20. A Light Detection and Ranging (LiDAR)-based object detection apparatus comprising:
a LiDAR sensor; and
a controller configured for performing object detection from a point cloud within a detecting range obtained by the LiDAR sensor,
wherein the object detection including:
determining a first object from a point cloud within a detecting range; and
determining a heading angle of the first object by a first method, and
wherein the first method including:
determining candidate straight lines for the heading angle of the first object; and
determining the heading angle of the first object from angles of the candidate straight lines.
